(19) United States
(12) Patent Application Publication
(10) Pub. No.: US 2012/0215930 A1
(43) Pub. Date: Aug. 23, 2012

(54) P-CSCF ADDRESS DISCOVERY

(75) Inventors: John Stenfelt, Goteborg (SE); Kaj Olof Inge Johansson, Molndal (SE); Hans-Ake Lund, Bohus (SE)

(73) Assignee: TELEFONAKTIEBOLAGET L M ERICSSON (PUBL), Stockholm (SE)

(21) Appl. No.: 13/502,814

(22) PCT Filed: Oct. 22, 2009
(86) PCT No.: PCT/EP09/63932

§ 371 Date: Apr. 19, 2012

(51) Int. Cl. G06F 15/16

(52) U.S. Cl. 709/228

(57) ABSTRACT

The present invention relates to a method for enabling IP multimedia system, IMS, signalling traffic in a Policy and Charging Control, PCC, environment between a user equipment (21), UE, and a proxy call session control function (16), P-CSCF, device. The method comprises the following steps: 1. The UE (21) requests (10) in a gateway (17), GW, at least one P-CSCF device address for IMS signalling traffic between the UE (21) and the P-CSCF device (16). 2. The GW (17) sends (11) a request for a policy decision for the IMS signalling traffic to a first policy control node (22,23), PCN. 3. The first PCN (22,23) responds (12) to PCN. the GW (17) with policy information defining the policy decision for the IMS signalling traffic, 4. The GW (17) installs (13) the policy information and provides the P-CSCF device address/-es assigned to said information to the UE (21). What particularly characterizes the method is a step where the first PCN (22, 23) defines (14) the policy information for the IMS signalling traffic. It is defined in the form of at least one instruction of at least one instruction, wherein the first PCN (22, 23) responds with the defined instruction/-s and with P-CSCF device address/-es assigned to said instruction/-s to the GW (17).

### TECHNICAL FIELD

The present invention relates to a method for enabling IP Multimedia System, IMS, signalling traffic in a Policy and Charging Control, PCC, environment between a User Equipment, UE, and a Proxy Call Session Control Function, P-CSCF. It also relates to a Gateway, a Policy Control Node and a system adapted for the same purpose.

### BACKGROUND

P-CSCF (Proxy Call Session Control Function) is a SIP (Session Initiation Protocol) proxy server that is the first point of contact for an IMS (IP Mulitmedia Subsystem) terminal. It can be located either in a visited network or in a home network. The P-CSCF is assigned to an IMS terminal during registration, and does not change for the duration of the registration. It sits on the path of all signalling messages, and can inspect every message. It further authenticates the user and establishes a security association with the IMS terminal.

Currently the P-CSCF (Proxy Call Session Control Function) discovery specified in the 3GPP standard supports three different variants for the UE/MS (User Equipment/Mobile Station) to resolve the address of the P-CSCF:
1. P-CSCF discovery Request and provision of P-CSCF address(es) in the PCO IE (Protocol Configuration Option Information Element) in the session management procedures. This option is based on configuration of the potential P-CSCF addresses in the GGSN or PDN-GW (Packet Data Network Gateway).
2. Via DHCP (Dynamic Host Configuration Protocol), servers i.e. the GGSN/PDN-GW shall provide the functionality of a DHCP agent.
3. Via DNS (Domain Name System) resolution of a P-CSCF FQDN (Fully Qualified Domain Name) that is pre-configured in the UE/MS. For this case the GGSN/PDN-GW shall be able to provide the DNS IP address(es) to the UE/MS.

The static packet filters shall be possible to pre-configure per APN (Access Point Name).

The current 3GPP (3^{rd} Generation Partnership Project) specification is based on the usage of pre-defined filters in the GGSN/PDN-GW for IMS signalling traffic. The pre-defined packet filters shall filter up-link and down-link packets and only allow traffic to/from the preconfigured signalling servers and to DNS and DHCP (Dynamic Host Configuration Protocol) servers. Typically this traffic use zero rate charging and a QoS (Quality of Service) that is dedicated for signalling.

This use of pre-defined filters implies that all P-CSCF addresses are known to the GGSN/PDN-GW in advance. However, when PCC (Policy and Charging Control) is used it would be possible for the PCRF (Policy and Charging Rules Function) to install dynamic PCC rules that explicitly allows the signalling traffic either on the default bearer or using dedicated bearer for IMS signalling traffic.

This requires that the PCRF knows which IP addresses that are P-CSCF addresses in order to assign the correct QCI (QoS Class Identifier) and other parameters for the SIP signalling Service Data Flow. Currently the P-CSCF address(es) are not known to the PCRF.

Furthermore, the 3GPP Rel8 architecture supports roaming through a Visited Access (also known as Local Breakout) with a P-CSCF located in the Home PLMN (Public Land Mobile Network). In order to support this kind of roaming scenarios the address of all the accessible P-CSCFs in all of the networks that the Visited PLMN operator has a roaming agreement with must consequently be configured in the PDN-GW. Such a solution would clearly suffer from scalability and maintainability related problems.

### SUMMARY

The object of the present invention is therefore to avoid that the Gateway has to maintain a complete and updated list of P-CSCF addresses.

The object of the present invention is solved by means of a method for enabling IP Multimedia System, IMS, signalling traffic. The traffic is enabled in a Policy and Charging Control, PCC, environment between a User Equipment, UE, and a Proxy Call Session Control Function, P-CSCF, device. The method comprises the steps of:
1. The UE requests in a Gateway, GW, at least one P-CSCF device address. The address is requested for IMS signalling traffic between the UE and the P-CSCF device.
2. The GW sends a request for a policy decision for the IMS signalling traffic to a first Policy Control Node, PCN.
3. The first PCN responds to the GW with policy information defining the policy decision for the IMS signalling traffic.
4. The GW installs the policy information. It further provides the P-CSCF device address/-es assigned to said information to the UE.

What particularly characterizes the method is that the first PCN defines the policy information for the IMS signalling traffic. The information is defined in the form of at least one instruction. The first PCN responds with the defined instruction/-s and with P-CSCF device address/-es assigned to said instruction/-s to the GW.

The object of the present invention is also solved by means of a Gateway, GW, adapted for enabling IP Multimedia System, IMS, signalling traffic. The traffic is enabled in a Policy and Charging Control, PCC, environment between a User Equipment, UE, and a Proxy Call Session Control Function, P-CSCF, device. The GW is adapted to:
1. Receive a request from the UE. The request relates to at least one P-CSCF device address for IMS signalling traffic between the UE and the P-CSCF device.
2. Send a request for a policy decision for the IMS signalling traffic to a first Policy Control Node, PCN.
3. Receive a response from the first PCN with policy information defining the policy decision for the IMS signalling traffic.
4. Install the policy information and provide the P-CSCF device address/-es assigned to said information to the UE,

What particularly characterizes the GW is that it is further adapted to receive the response from a first PCN. The response contains the defined instruction/-s and P-CSCF device address/-es assigned to said instruction/-s.

The object of the present invention is also solved by means of a Policy Control Node, PCN, adapted to enable IP Multimedia System, IMS, signalling traffic. The traffic is enabled in a Policy and Charging Control, PCC, environment between a User Equipment, UE, and a Proxy Call Session Control Function. The PCN is adapted to:
1. Receive a request for a policy decision for the IMS signalling traffic from a GW.
2. Respond to the GW with policy information defining the policy decision for the IMS signalling traffic.

What particularly characterizes the PCN is that it is further adapted to define the policy information for the IMS signalling traffic. The information is defined in the form of at least one instruction. The first PCN responds with the defined instruction/-s and with P-CSCF device address/-es assigned to said instruction/-s to a GW according to any of the claims 8-11.

The object of the present invention is finally solved by means of a system adapted to enable IP Multimedia System, IMS, signalling traffic. The traffic is enabled in a Policy and Charging Control, PCC, environment between a User Equipment, UE, and a Proxy Call Session Control Function.
1. A Gateway, GW, in the system is adapted to receive a request from the UE. The request relates to at least one P-CSCF device address for IMS signalling traffic between the UE and the P-CSCF device.
2. The GW is further adapted to send a request for a policy decision for the IMS signalling traffic to a first Policy Control Node, PCN, in the system.
3. The first PCN is adapted to respond to the GW with policy information defining the policy decision for the IMS signalling traffic.
4. The GW is further adapted to install the policy information and provide the P-CSCF device address/-es assigned to said information to the UE.

What particularly characterizes the system is that the PCN is further adapted to define the policy information for the IMS signalling traffic. The information is defined in the form of at least one instruction. The first PCN responds with the defined instruction/-s and with P-CSCF device address/-es assigned to said instruction/-s to the GW.

The main advantage with the present invention is that it will efficiently eliminate the problem related to roaming with the Local Breakout (roaming) scenarios and P-CSCF device in the home PLMN. The reason is that there will be no need to maintain a complete and updated list of P-CSCF device addresses in the GW. The proposed solution also solves the case of how to define dynamic PCC rules to be used for IMS signalling without having to pre-configure this information in the GW (GGSN or PDN-GW).

Additional advantages are achieved by implementing one or several of the features of the dependent claims not mentioned above. This will be further explained below.

### BRIEF DESCRIPTION OF THE DRAWINGS

The invention will be described in greater detail in the following, with reference to the embodiments that are shown in the attached drawings, in which:

FIG. 1 illustrates a simplified overview of 3G and LTE (Long Term Evolution) access with IMS.

FIG. 2 illustrates the method according to the present invention.

FIG. 3 illustrates the mechanisms (existing and according to the present invention) for P-CSCF address discovery.

FIG. 4 illustrates the Gateway logic for the existing mechanism.

FIG. 5 illustrates the PCRF logic for the existing mechanism.

FIG. 6 illustrates the Gateway logic for a first example of a mechanism according to the present invention.

FIG. 7 illustrates the PCRF logic for a first example of a mechanism according to the present invention.

FIG. 8 illustrates the Gateway logic for a second example of a mechanism according to the present invention.

FIG. 9 illustrates the PCRF logic for a second example of a mechanism according to the present invention.

### DETAILED DESCRIPTION

The present invention relates to method for enabling IP Multimedia System, IMS, signalling traffic in a Policy and Charging Control, PCC, environment between a User Equipment, UE, and a Proxy Call Session Control Function, P-CSCF, device. It also relates to a Gateway, a Policy Control Node and a system adapted for the same purpose. A person skilled in the art would realize that a Gateway, a Policy Control Node and a system adapted to perform said method described below are also disclosed in the following. IMS Signalling traffic relates to the signalling traffic between the UE and the P-CSCF device. However, the person skilled in the art would realize that the fact that this method relates to the IMS signalling traffic does not exclude that the method can be combined with other data traffic between the UE and different parts of a system. Such traffic for instance relates to a request from the UE to the system regarding a PDN (Packet Data Network) connection for data traffic.

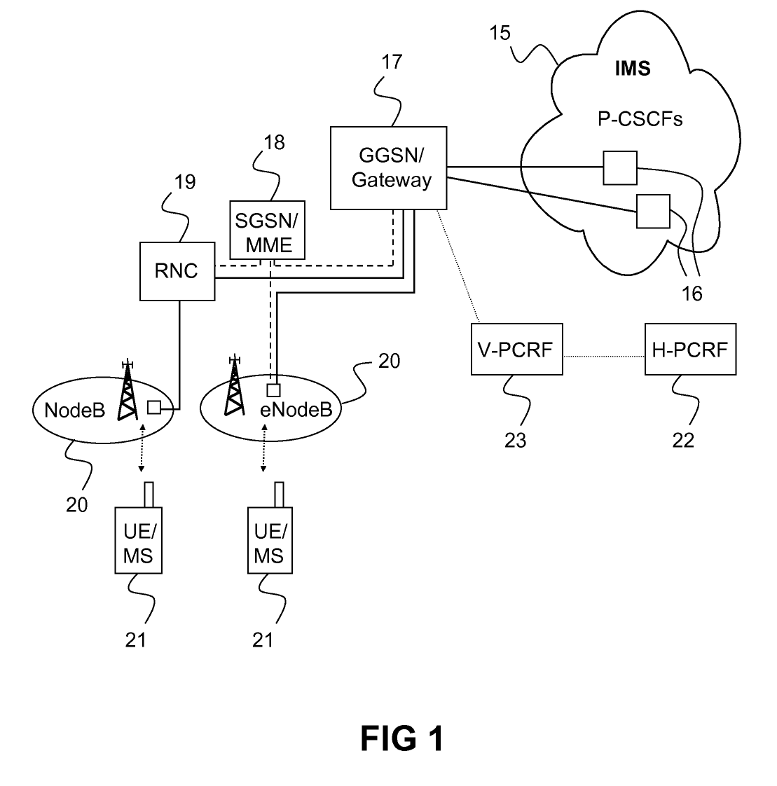

FIG. 1 illustrates a simplified overview of 3G and LTE (Long Term Evolution) access with IMS. The dotted lines relates to signalling traffic while the continuous lines relates to payload traffic. It shows how the IMS function 15 with P-CSCF devices 16 connects to 3GPP EPS (Evolved Packet System) with GGSN/Gateway 17 (Gateway GPRS-General Packet Radio System-Support Node), an SGSN/MME 18 (Serving GPRS Support Node) and a RNC 19 (Radio Network Controller). FIG. 1 also shows eNodeB's and NodeB's 20 and UE/MS's 21 (User Equipment/Mobile Stations). The 3GPP system will not be described further in detail in this patent application.

The P-CSCF device 16 is a SIP (Session Initiation Protocol) proxy that is the first point of contact for the UE (IMS terminal). It can be located either in the visited network (in full IMS networks) or in the home network (when the visited network isn't IMS compliant yet). The P-CSCF is assigned to the UE during registration, and does not change for the duration of the registration. It sits on the path of all signalling messages, and can inspect every message. It further authenticates the user and establishes a security association with the IMS terminal. The P-CSCF device will in the following be named P-CSCF.

PCN's (Policy Control Node) in the form of a H-PCRF 22 (Home-Policy and Charging Rules Function) and a V-PCRF 23 (Visited-Policy and Charging Rules Function) are also shown in FIG. 1. In the following, the PCN's will be exemplified by PCRF's. The GGSN/Gateway 17 in FIG. 1 will be called Gateway or GW in the following. Other Gateways, such as PDN-GW (Packet Data Network-Gateways) are also included within the term Gateway/GW.

The PCRF responds with policy decisions to the GW in the form of instructions. These will in the following be named rules. These rules/instructions comprise a set of information enabling the detection of a service data flow and providing parameters for policy control and/or charging control. Further definition PCRF provision of rules can be found in 3GPP.

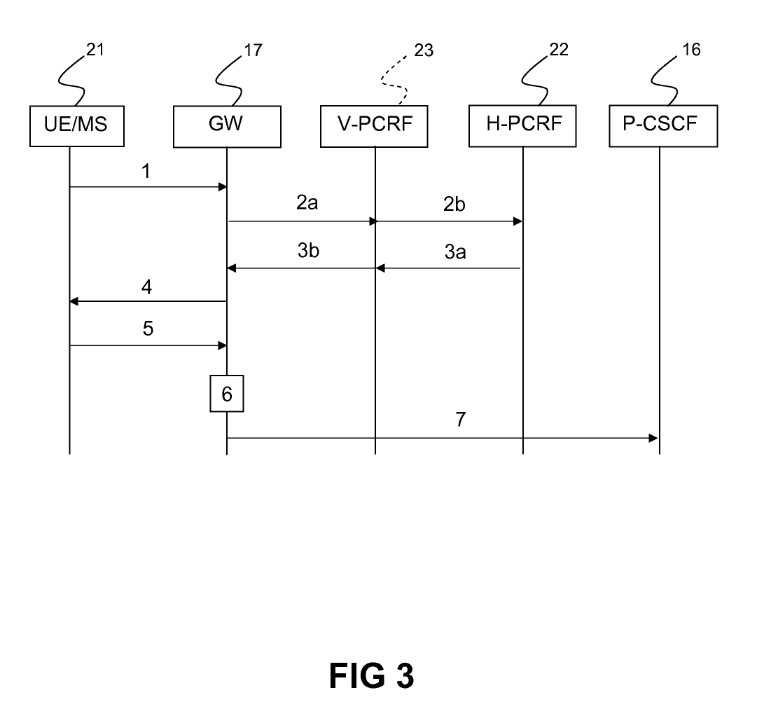

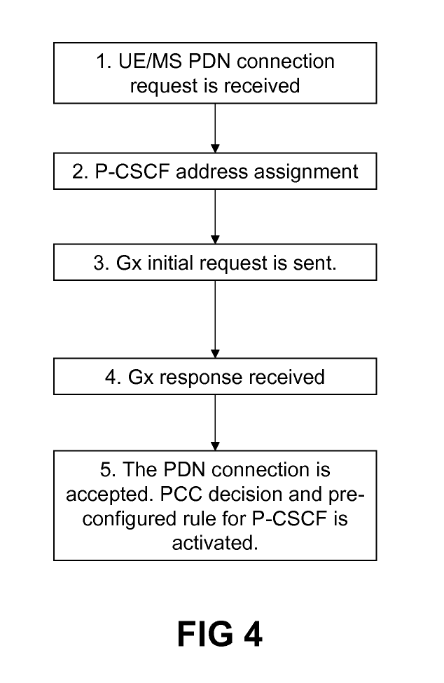

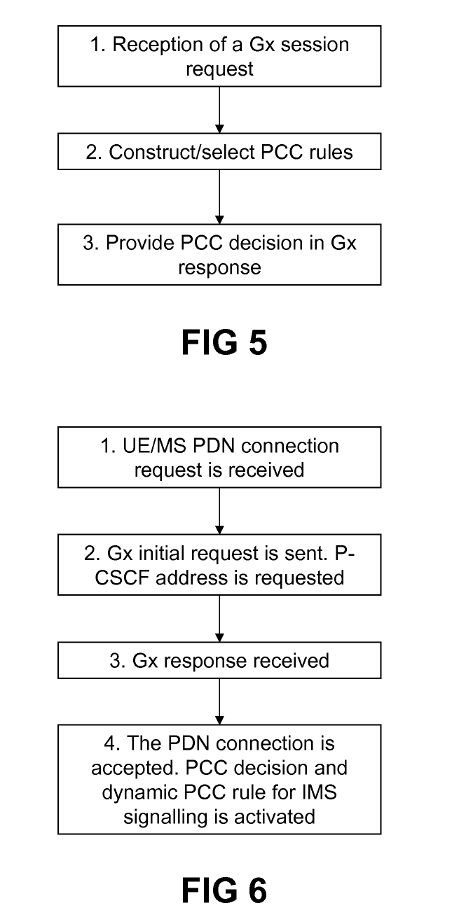

On the basis of FIGS. 3-5, an existing solution for P-CSCF address discovery is shown. FIG. 4 illustrates the gateway logic for the existing mechanism while FIG. 5 illustrates the PCRF logic for the existing mechanism. FIG. 4 illustrates the following:
1. The UE/MS 21 requests a new PDN connection and requests a P-CSCF address in a PCO field. The GW 17 assigns P-CSCF address(es) to the UE locally configured on the node. Optionally there may be QoS (Quality of Service) configured for the P-CSCF address(es) to achieve dedicated QoS for IMS signaling. Further Charging-Key/Rating-Group for zero-rate charging may be configured. These locally pre-defined policies are unknown in the PCRF. The P-CSCF addresses locally configured will only be within the operator network. Thus, local breakout with use of home operator's application functions will not apply.
2. a) The GW (GGSN or PDN-GW) initiates a Gx session. b) In case of roaming with local breakout the V-PCRF 23 forwards the request to the H-PCRF 22 over reference point S9.

3. The H-PCRF takes a policy decision for the end user and sends it back via the V-PCRF. The V-PCRF may apply additional policy decision and add this to the response back to the GW.
4. The GW deploys the received policy decision and accepts the UE/MS PDN connection request. In addition, the GW may pre-establish a dedicated bearer for the IMS signaling traffic if dedicated QoC is configured. The assigned P-CSCF address(es) are also provided in the PCO field back to the UE/MS. Additional setup of bearers may take place.
5. The UE/MS sends a SIP (Session Initiation Protocol) register message in the payload path to the P-CSCF that can only be in the V-PLMN.
6. The request matches a local rule installed for IMS signaling in the GW for this PDN-connection. The packet is authorized. Zero charging can be applied.
7. The IMS Register message is forwarded to the destination P-CSCF. Further IMS signaling takes place (not shown in the example).

FIG. 4 illustrates the GW 17 logic in the existing method:
1. A PDN connection request is received at the GW 17. A P-CSCF address is requested in the PCO field.
2. The GW assigns one or several P-CSCF addresses to the PDN connection.
3. The GW initiates a Gx Diameter session for the PDN connection.
4. A response to the outstanding Gx request is received containing PCC decisions.
5. The GW accepts the PDN connection and includes the assigned P-CSCF addresses in the PCO IE that is signaled to the UE. The PCC decisions received over Gx are deployed and pre-defined rules for communication with the assigned P-CSCF address(es) are activated.

FIG. 5 illustrates the PCRF 22,23 logic in the existing method
1. A request for a new Gx Diameter session is received at the PCRF 22,23.
2. The PCRF takes a decision what policies shall apply for the session.
3. The Gx request is accepted and the applicable policy decisions are provided in a Gx response to the GW.

In the following, the inventive method enabling IP Multimedia System, IMS, signalling traffic in a Policy and Charging Control, PCC, environment between a User Equipment, UE, and a Proxy Call Session Control Function, P-CSCF, will be described. The method is intended to solve the problem of having to maintain a complete and updated list of P-CSCF addresses in the Gateway 17. With the existing method according to FIGS. 3-5, the Gateway has to maintain such a list.

The accesses are in the following for instance (see FIG. 1) GERAN (GSM Radio Access Network), UTRAN (UMTS Terrestial Radio Access Network), E-UTRAN (Evolved UTRAN) or non-3GPP accesses, see FIG. 1. A person skilled in the art would realize that other types of accesses are also embraced within the term “access”.

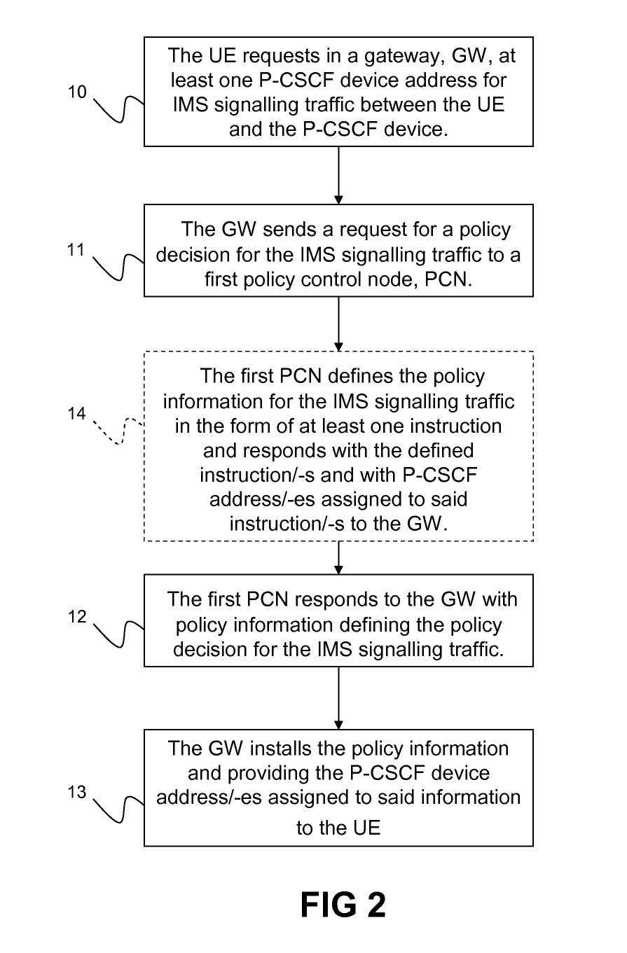

In the present invention the following method steps are performed, see FIG. 2:
1. The UE 21 requests 10 in a Gateway, GW, 17 at least one P-CSCF address for IMS signalling traffic between the UE and the P-CSCF 16.
2. The GW sends 11 a request for a policy decision for the IMS signalling traffic to a first PCRF 22,23.
3. The first PCRF responds 12 to the GW with policy information defining the policy decision for the IMS signalling traffic.
4. The GW installs 13 the policy information and provides the P-CSCF address/-es assigned to said information to the UE.

What particularly characterizes the method is that the first PCRF defines 14 the policy information for the IMS signalling traffic. It is defined in the form of at least one rule, wherein the first PCRF responds with the defined rule/-s and with P-CSCF address/-es assigned to said rule/-s to the GW. This characterizing part of the method, performed by the first PCRF, is performed between step 2 and 3, and in step 3. Steps 1-4 are part of commonly known and used procedures (see FIG. 2) while the characterizing part of the method is the new part of the procedure. This is also illustrated in FIG. 2, in that the box with reference 14 is positioned between step 2 and 3.

In the inventive procedure, the PCRF makes sure that the GW has updated information about the P-CSCF addresses relevant for a certain policy decision. This significantly improves the handling of P-CSCF addresses, since a need to maintain a complete address list requires procedures for maintaining and updating the list. Moreover, in roaming scenarios, with the existing solution, the address of all the accessible P-CSCFs in all of the networks that a Visited PLMN operator has a roaming agreement with must be maintained in the complete list and configured in the Gateway 17.

In the following two examples will be described of how the GW 17 updates P-CSCF addresses for a certain policy decision. In both examples, the GW and the first PCRF 22 may communicate directly or via a second PCRF 23. If they communicated directly, they are located in the same PLMN (Public Land Mobile Network). A second PCRF is involved in a roaming scenario with visited access (also known as Local Breakout). The first PCRF consists in a home PLMN PCRF (H-PCRF) and the second PCRF consists in a visited PLMN PCRF (V-PCRF), see FIG. 1. In the following, the first PCRF will be named H-PCRF and the second PCRF will be named V-PCRF.

In a first example, the GW 17 includes a request for P-CSCF address/-es in the request. H-PCRF 22 then assigns P-CSCF address/-es to the rule/-s. In the first example, H-PCRF 22 will be configured to assign the P-CSCF address(es) and to send it either directly to the GW 17 over a Gx interface or via V-PCRF 23 over a S9 interface. This will solve the problems related to roaming with local breakout when the P-CSCF 17 is located in the HPLMN (Home Public Land Mobile Network). It will also make it possible for the H-PCRF 22 to define appropriate dynamic PCC rules that make the configuration and assignment of QoS parameters for the SIP signalling more consistent in an IMS system.

In a second example, the GW 17 instead includes assigned P-CSCF address/-es in the request. H-PCRF 22 may accept the P-CSCF address/-es in the request and assign said address/-es to the rule/-s. In the second example, H-PCRF may instead assign P-CSCF address/-es to the rule/-s. In case of roaming with local breakout, when a P-CSCF in the VPLMN (Visited Public Land Mobile Network) should be used, P-CSCF addresses are configured in the GGSN/P-GW or DHCP (Dynamic Host Configuration Protocol). If this is the case (when PCC is used), then H-PCRF would require the assigned P-CSCF address(es) in order to be able to define appropriate PCC rules to be used for the signalling traffic. Therefore, when the P-CSCF addresses are not assigned by the H-PCRF then those addresses should be provided to H-PCRF.

In the examples, a Gx session is used. A Gx session is a communication between the GW 17 and the PCRF via an interface/reference point Gx. In the session the GW sends information and/or a request to the PCRF and the PCRF responds with a policy decision.

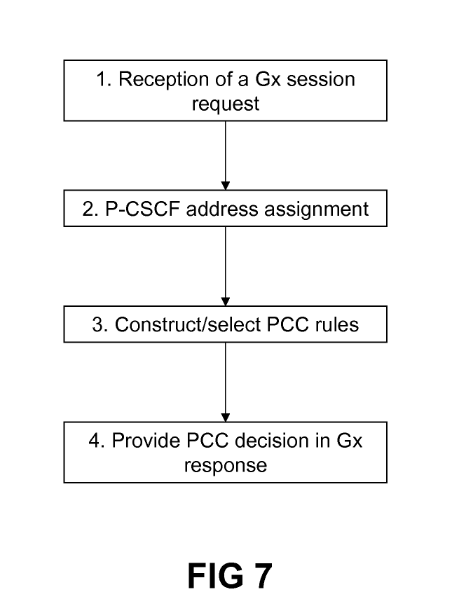

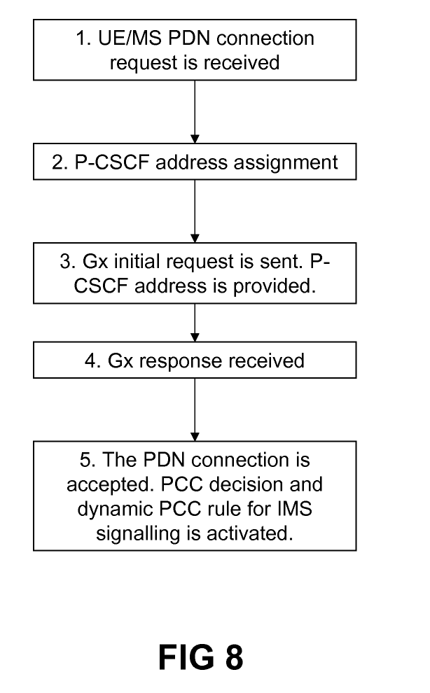

Firstly, with reference to FIGS. 3 and 6-7 the first example of a mechanism for P-CSCF address discovery is shown. FIG. 7 illustrates the Gateway logic for the first example while FIG. 8 illustrates the PCRF logic for the first example. FIG. 3 illustrates the following (the differences compared to the existing solution are marked in bold):
1. The UE/MS 21 requests a new PDN connection and requests a P-CSCF address in a PCO field.

2. a) The GW 17 (GGSN or PDN-GW) initiates a Gx session and a request for P-CSCF addresses.

b) In case of roaming with local breakout the V-PCRF 23 forwards the request to the H-PCRF 22 over reference point S9.
3. The H-PCRF takes a policy decision for the end user and sends it back via the V-PCRF. The V-PCRF may apply additional policy decision and add this to the response back to the GW.

In addition, the H-PCRF assigns P-CSCF addresses in the H-PLMN. It then defines a PCC rule for the IMS traffic between the MS/UE and the P-CSCF address(es) in the home network.

The request from step 2 is accepted and the PCC rules for IMS signaling traffic is provided back to the GW. The P-CSCF address(es) are provided back to the GW in the response message.
4. The GW installs the received policy decision including the PCC rules for IMS signaling and accepts the UE/MS connection request. The assigned P-CSCF address(es) from the PCRF response are provided in the PCO field. Additional setup of bearers (i.e. for dedicated IMS signaling) may take place.
5. The UE/MS sends a SIP (Session Initiation Protocol) register message in the payload path to the P-CSCF that can be in the V-PLMN or in the H-PLMN.
6. The request matches the installed dynamic PCC rule for IMS signaling in the GW for this PDN-connection. The packet is authorized.
7. The IMS Register message is forwarded to the destination P-CSCF.

Further IMS signaling takes place (not shown in the example).

FIG. 6 illustrates the GW 17 logic in the first example (the differences compared to the existing solution are marked in bold):
1. A PDN connection request is received at the GW 17. A P-CSCF address is requested in the PCO field.
2. The GW initiates a Gx Diameter session for the PDN connection. The message includes a request for P-CSCF address(es).
3. A response to the outstanding Gx request is received containing PCC decisions, PCC rules for the IMS signaling traffic and associated P-CSCF address(es).
4. The GW accepts the PDN connection and includes the assigned P-CSCF addresses assigned by the PCRF 22, 23 in the PCO IE that is signaled to the UE. The PCC decisions received over Gx are deployed including the rules for IMS signaling traffic.

FIG. 7 illustrates the PCRF 22,23 logic in the first example (the differences compared to the existing solution are marked in bold):
1. A request for a new Gx Diameter session is received at the PCRF 22,23. The message includes a request for P-CSCF address(es).
2. The PCRF assigns one or several P-CSCF addresses to the PDN connection.
3. The PCRF takes a decision what policies shall apply for the session.

It defines a PCC rule for the IMS signaling traffic between the MS/UE 21 and the P-CSCF address(es) in the home network.
4. The Gx request is accepted and the applicable policy decisions including the P-CSCF address(es) and the PCC rule for IMS signaling traffic are provided in a Gx response to the GW.

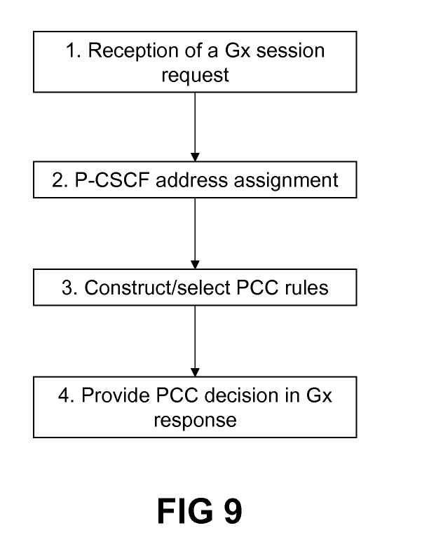

Secondly, with reference to FIGS. 3 and 8-9 the second example of a mechanism for P-CSCF address discovery is shown. FIG. 8 illustrates the Gateway logic for the first example while FIG. 9 illustrates the PCRF logic for the first example. FIG. 3 illustrates the following (the differences compared to the existing solution are marked in bold):
1. The UE/MS 21 requests a new PDN connection and requests a P-CSCF address in a PCO field.
2. a) The GW 17 (GGSN or PDN-GW) initiates a Gx session and includes P-CSCF address(es) in the request.
b) In case of roaming with local breakout the V-PCRF 23 forwards the request to the H-PCRF 22 over reference point S9.
3. The H-PCRF takes a policy decision for the end user and sends it back via the V-PCRF. The V-PCRF may apply additional policy decision and add this to the response back to the GW.

The H-PCRF assigns P-CSCF addresses in the H-PLMN or accepts the assigned P-CSCF address(es) provided by the GW. In this case, H-PCRF accepts P-CSCF addresses provided by GW.

H-PCRF defines a PCC rule for the IMS signaling traffic between the MS/UE and the P-CSCF address(es) with use of the assigned P-CSCF address(es).

The Request from step 2 is accepted and the PCC rule for IMS signaling traffic is provided back to the GW.

In addition PCRF indicates back to the GW the assigned P-CSCF address(es).
4. The GW installs the received policy decision including the PCC rules for IMS signaling and accepts the UE/MS connection request. The assigned P-CSCF address(es) indicated by PCRF are provided in the PCO field. Additional setup of bearers (i.e. for dedicated IMS signaling) may take place.
5. The UE/MS send a SIP (Session Initiation Protocol) register message in the payload path to the P-CSCF that can be in the V-PLMN or in the H-PLMN.
6. The request matches the installed dynamic PCC rule for IMS signaling in the GW for this PDN-connection. The packet is authorized.
7. The IMS Register message is forwarded to the destination P-CSCF. Further IMS signaling takes place (not shown in the example).

FIG. 8 illustrates the GW 17 logic in the second example (the differences compared to the existing solution are marked in bold):
1. A PDN connection request is received at the GW 17. A P-CSCF address is requested in the PCO field.
2. The GW 17 assigns one or several P-CSCF addresses to the PDN connection.
3. The GW initiates a Gx Diameter session for the PDN connection. The message includes the assigned (candidate) P-CSCF address(es).
4. A response to the outstanding Gx request is received containing PCC decisions, PCC rules for the IMS signaling traffic and associated (selected) P-CSCF address(es).
5. The GW accepts the PDN connection and includes the assigned P-CSCF addresses in the PCO IE that is signaled to the UE. The PCC decisions received over Gx are deployed including the rules for IMS signaling traffic.

FIG. 9 illustrates the PCRF 22,23 logic in the second example (the differences compared to the existing solution are marked in bold):

1. A request for a new Gx Diameter session is received at the (H-)PCRF 22,23. The message includes assigned (candidate) P-CSCF address(es).

2. The H-PCRF assigns P-CSCF address(es) in the H-PLMN or accepts the assigned P-CSCF address(es) provided by the GW.

3. The PCRF takes a decision what policies shall apply for the session. It defines a PCC rule for the IMS signaling traffic between the MS/UE 21 and the (selected) P-CSCF address(es).

4. The Gx request is accepted and the applicable policy decisions including the (selected) P-CSCF address(es) and the PCC rule for IMS signaling traffic are provided in a Gx response to the GW.

The invention is not to be regarded as being limited to the examples shown in FIGS. 3-9 and described above. A number of additional variants and modifications are possible within the scope of the subsequent patent claims.

For instance, the basic principles in the examples above are equally applicable for the case when DHCP (Dynamic Host Configuration Protocol) is used to retrieve the P-CSCF addresses. For this case the assignment of P-CSCF address takes place after the PDN-connection (and the associated Gx session) has been established. For this case step one would be the UE/MS sending a DHCPv4 request or a DHCPv6information-request to the GW. The GW would function as a DHCP relay agent and should initiate step 2 in the figure above as Gx update request (since the Gx session is already established). Step 5 in this case would then correspond to DHCPv4Ack/DHCPv6 reply from the GW to the UE/MS containing the assigned P-CSCF addresses.

1. A method for enabling IP multimedia system, IMS, signalling traffic in a Policy and Charging Control, PCC, environment between a user equipment, UE, and a proxy call session control function, P-CSCF, device), the method comprising the steps of:
the UE requesting in a gateway, GW, at least one P-CSCF device address for IMS signalling traffic between the UE and the P-CSCF device;
the GW sending a request for a policy decision for the IMS signalling traffic to a first policy control node, PCN;
the first PCN responding to the GW with policy information defining the policy decision for the IMS signalling traffic;
the GW installing the policy information and providing the P-CSCF device address assigned to said information to the UE; and
the first PCN defining the policy information for the IMS signalling traffic in the form of at least one instruction and responding with the defined instruction and with a P-CSCF device address assigned to said instruction to the GW.

2. A method according to claim 1, wherein the GW and the first PCN communicates via a second PCN.

3. A method according to claim 2, wherein the first PCN is provide in a home network PCN and wherein the second PCN is provided in a visited network PCN.

4. A method according to claim 1, wherein the GW includes a request for a P-CSCF device address in the request.

5. A method according to claim 1, wherein the GW includes an assigned P-CSCF device address in the request.

6. A method according to claim 5, wherein the first PCN accepts the P-CSCF device address in the request and assigns said address to the instruction.

7. A method according to claim 4, wherein the first PCN assigns a P-CSCF device address to the instruction.

8. A gateway, GW, configured for enabling IP multimedia system, IMS, signalling traffic in a policy and charging control, PCC, environment between a user equipment, UE, and a proxy call session control function, P-CSCF, device, the GW configured to:
receive a request from the UE of at least one P-CSCF device address for IMS signalling traffic between the UE and the P-CSCF device;
send a request for a policy decision for the IMS signalling traffic to a first Policy Control Node, PCN;
receive a response from the first PCN with policy information defining the policy decision for the IMS signalling traffic;
install the policy information and provide the P-CSCF device address assigned to said information to the UE; and
receive the response from the first PCN with the defined instruction and with the P-CSCF device address assigned to said instruction.

9. A GW according to claim 8, wherein the GW is adapted to communicate with the first PCN via a second PCN.

10. A GW (17) according to claim 8, wherein the GW is adapted to include a request for a P-CSCF device address in the request.

11. A GW according to claim 8, wherein the GW is adapted to include an assigned P-CSCF device address in the request.

12. A policy control node, PCN, configured to enable IP multimedia system, IMS, signalling traffic in a policy and charging control, PCC, environment between a user equipment, UE, and a proxy call session control function, P-CSCF, device, the PCN configured to:
receive a request for a policy decision for the IMS signalling traffic from a GW;
respond to the GW with policy information defining the policy decision for the IMS signalling traffic; and
define the policy information for the IMS signalling traffic in the form of at least one instruction and respond with the defined instruction and with a P-CSCF device address assigned to said instruction to a GW.

13. A PCN according to claim 12, wherein the PCN is adapted to communicate with the GW via a second PCN.

14. A PCN according to claim 13, wherein the first PCN is provided in a home network PCN (22) and wherein the second PCN is provided in a visited network PCN.

15. A PCN according to claim 12, wherein the PCN is further configured to accept a P-CSCF device address in the request and assign said address to the instruction.

16. A PCN (22,23) according to claim 12 wherein the PCN (22,23) is adapted to assigns a P-CSCF device address to the instruction.

17. A system configured to enable IP multimedia system, IMS, signalling traffic in a policy and charging control, PCC, environment between a user equipment, UE, and a proxy call session control function, P-CSCF device, comprising:
a gateway, GW, in the system configured to receive a request from the UE, the UE in the request requesting at least one P-CSCF device address for IMS signalling traffic between the UE and the P-CSCF device;
the GW further configured to send a request for a policy decision for the IMS signalling traffic to a first policy control node, PCN, in the system;
the first PCN configured to respond to the GW with policy information defining the policy decision for the IMS signalling traffic;
the GW further configured to install the policy information and provide the P-CSCF device address assigned to said information to the UE; and
the first PCN is further configured to define the policy information for the IMS signalling traffic in the form of at least one instruction and respond with the defined instruction and with a P-CSCF device address assigned to said instruction to the GW.
